(19) United States
(12) Patent Application Publication
(10) Pub. No.: US 2026/0069902 A1
(43) Pub. Date: Mar. 12, 2026

(54) CONTAINER WITH STORAGE SYSTEM AND FIRE SUPPRESSANT

(71) Applicant: Fire Containers Limited, Cheadle (GB)

(72) Inventor: Neil Darren PEDERSEN, Stoke-On-Trent (GB)

(21) Appl. No.: 19/324,746

(22) Filed: Sep. 10, 2025

(30) Foreign Application Priority Data
Sep. 11, 2024 (GB) 2413385.2

(51) Int. Cl. A62C 3/00

(52) U.S. Cl. CPC A62C 3/002

(57) ABSTRACT

A container 100 for storing flammable articles, optionally batteries, the container 100 comprising: an enclosure 102 defining an interior space 104, the enclosure 102 comprising at least one door 112 for accessing the interior space 104; a recirculating fluid delivery system 200 comprising one or more tanks 202, 210 configured to store a fire suppressant, and a plurality of fluid outlets 214 configured to output the fire suppressant into the interior space 104; and a storage system 300 within the interior space 104, the storage system comprising a plurality of compartments 302, optionally vertically spaced shelves, each configured to store one or more of the flammable articles.

### CROSS-REFERENCE TO RELATED APPLICATIONS

This application claims priority to Great Britain Patent Application No. 2413385.2, filed Sep. 11, 2024, the entire contents of which are incorporated herein by reference.

### FIELD OF THE INVENTION

Embodiments of the present invention relate to a container with a storage system and fire suppressant. In particular, but not exclusively, they relate to a battery storage container with a battery storage system, one or more fire detectors, and fire suppressant.

### BACKGROUND TO THE INVENTION

When many flammable articles such as batteries are stored, a fault in one flammable article can cause a fire which spreads to other flammable articles. The resulting chain reaction can result in a fire which is difficult to contain or control.

The present disclosure is applicable to a range of flammable articles not limited to batteries. However, many aspects of the disclosure are particularly relevant to battery storage.

Some battery chemistries, such as lithium-ion chemistries, are particularly vulnerable to thermal runaway incidents resulting from internal short circuits. The lithium salts in the batteries are self-oxidising, meaning that large fires can develop even in confined spaces with limited atmospheric oxygen. For the same reason, conventional oxygen-starving fire extinguishers will struggle to extinguish battery fires.

When batteries have been installed in end products, the risks of battery fires are controlled in various ways. For example, stationary battery energy storage systems (BESS), and battery packs for transportation, are designed with air-cooling systems or liquid-cooling systems to minimise the chance of a thermal runaway. Storage systems for the battery cells are designed to reduce the risk of mechanical damage or a fire, and may be compartmentalised to isolate fires and prevent them from spreading.

However, before flammable articles have been installed in end products, they need to be manufactured and then transported via a supply chain. The transition towards a green economy has significantly increased the number of battery cells or battery modules being stored in the supply chain, for example in warehouses or similar facilities. The facility may be provided with climate control, as well as detectors and fire suppression systems. However, if a fire does break out, significant damage may occur to the facility before the fire is contained. Several recent high-profile events have raised safety issues, and have increased insurance costs in the supply chain.

### BRIEF DESCRIPTION OF VARIOUS EMBODIMENTS OF THE INVENTION

According to various, but not necessarily all, embodiments of the invention there is provided a container for storing flammable articles, optionally batteries, the container comprising:
an enclosure defining an interior space, the enclosure comprising at least one door for accessing the interior space;
a recirculating fluid delivery system comprising one or more tanks configured to store a fire suppressant, and a plurality of fluid outlets configured to output the fire suppressant into the interior space; and
a storage system within the interior space, the storage system comprising a plurality of compartments, optionally vertically spaced shelves, each configured to store one or more of the flammable articles.

An advantage is a fire-safe environment for storing flammable articles. If a fire breaks out, the enclosure contains the fire and prevents or delays it from spreading inside or outside of the container. The enclosure further helps to prevent outside oxygen from entering the space. Therefore, the fire can be confined to the container for a long duration, and may be extinguished within the container. This protects surrounding buildings and infrastructure from fire damage, and a lot of the smoke may be contained or reduced due to early fire interactions.

Furthermore, the onboard tank means that the container has its own onboard supply of fire suppressant. Therefore, the container can be portably deployed in environments where an external supply of fire suppressant is not readily available.

Optionally, the vertically spaced shelves define the compartments. Alternatively, a plurality of horizontally spaced upright frames positioned alongside each other define the compartments.

Optionally, the enclosure comprises a base, side walls, a roof, and the at least one door, collectively sealing the interior space from an external environment for at least a lower portion of a total height of the container.

An advantage is that at least the lower parts of the container are substantially fluid-tight to prevent leakage of smoke or fire suppressant. Optionally, as described later, one or more ventilation ports may be provided at an upper portion of the container. Therefore, the entire container may be sealed except the one or more ventilation ports.

Optionally, the fire suppressant comprises a liquid. Optionally, the fire suppressant comprises a cooling agent. Optionally, the cooling agent comprises water.

An advantage is that water has a cooling effect on a battery fire, which reduces the temperature of the flammable article to a sub-ignition temperature. Therefore, even a lithium-ion battery fire can be contained and controlled.

Optionally, the plurality of fluid outlets are configured to output an atomised mist of the liquid fire suppressant.

An advantage of atomising the fire suppressant into a mist is a high surface area-to-volume ratio of droplets, to increase heat absorption by the fire suppressant. A further advantage is that the mist is suspended in the air and can therefore reach around obstacles and into crevices. A further advantage is that mist has reduced electrical conductivity compared to larger droplets, to reduce the probability of electrical short circuits. A further advantage is that the wet mass of the container is reduced, compared to a container with enough fire suppressant to fully submerge the storage system. A further advantage is that if the liquid is water, the water mist expands to steam when exposed to heat, which further reduces available oxygen.

Optionally, the container comprises a peripheral mist circulation gap extending between at least one elongate side of the storage system and a corresponding side wall of the enclosure, in plan view. Optionally, the peripheral mist circulation gap is located at least at a plurality of opposite elongate sides of the storage system, in plan view. Optionally, the peripheral mist circulation gap extends continuously around three or four elongate sides of the storage system, in plan view. Optionally, the peripheral mist circulation gap surrounds an entire circumference of the storage system, separating the storage system from the side walls of the enclosure, in plan view. Optionally, a plan view width of the peripheral mist circulation gap, from the side wall of the enclosure to a corresponding/parallel shelf edge of the storage system, is at least 15 cm or at least 20 cm, on average.

An advantage is improved fire suppression. By sacrificing a small amount of plan view storage space, a gap is provided which allows mist to circulate widely around the container to reach all sides of all the shelves. This also reduces the number of fluid outlets that may be required. The container may still have a substantial plan view area available for storage, especially if the container is also provided with a later-described floor tank and/or exterior wall-mounted tank for storing fire suppressant without reducing the plan view area of the interior space.

Optionally, the peripheral mist circulation gap has a height at least equal to a height of the storage system. Optionally, the height of the storage system is measured to at least a top shelf height of the storage system.

Optionally, a first one of the shelves comprises an upright barrier arrangement extending along at least one edge region of the first shelf, to restrain a flammable article on the first shelf against falling into the peripheral mist circulation gap. The upright barrier arrangement may be a side wall of the shelf, connected to a horizontal shelf plate of the shelf. Optionally, each shelf comprises an upright barrier arrangement as described.

Optionally, the upright barrier arrangement extends around part of the perimeter of the first shelf (or each shelf). Optionally, the upright barrier arrangement comprises a discontinuity extending along an edge region of a side of the first shelf, the discontinuity providing an entrance through which flammable articles can be inserted onto the first shelf and withdrawn from the first shelf.

Optionally, the upright barrier arrangement comprises a plurality of apertures to allow misted fire suppressant to pass through the apertures of the upright barrier arrangement towards the flammable article on the first shelf. For example, optionally the upright barrier arrangement comprises a mesh panel.

Optionally, the container comprises a floor of the interior space, the floor comprising a sloped portion and a flat portion, wherein the sloped portion is orientated to drain the fire suppressant towards a sump inlet.

An advantage is that fire suppressant can be recovered in a sump, for example so that it can be recirculated or pumped out of the container. An advantage of the flat portion is providing a level surface for the sump inlet and/or for the storage system to rest on.

Optionally, the sloped portion of the floor is located between the storage system and a side wall of the enclosure. Optionally, the sloped portion of the floor extends along the peripheral mist circulation gap and is sloped towards a centreline of the container.

Optionally, at least part of the flat portion of the floor is configured to receive a weight load from the storage system.

Optionally, the sump inlet is provided on the flat portion of the floor, beneath the storage system.

Optionally, the one or more tanks comprise a floor tank, the floor tank comprising an upper wall defining or supporting the floor of the interior space. Optionally, feet of the storage system rest on the flat portion of the floor, and are supported by the upper wall of the floor tank. Optionally, the upper wall of the floor tank defines the sloped portion and at least part of the flat portion of the floor.

An advantage of the floor tank is improved portability of the container because the height of the centre of gravity of the container is minimised. A further advantage is allowing a large volume of fire suppressant to be stored without reducing the plan view dimensions of the container.

Optionally, the recirculating fluid delivery system comprises a plurality of sprinkler conduits, and a plurality of nozzles connected to each sprinkler conduit and separated longitudinally or vertically from each other along the respective sprinkler conduit, each nozzle defining one of the plurality of fluid outlets. Optionally, each sprinkler conduit comprises a sprinkler pipe. Optionally, each fluid outlet comprises a plurality of atomising holes formed in the nozzle.

An advantage is that a limited number of sprinkler conduits can supply a large number of nozzles, allowing rapid complete coverage of the interior space with mist in the event of detected fire, heat, or smoke.

Optionally, each sprinkler conduit extends along a respective side wall of the enclosure. Optionally, the plurality of sprinkler conduits includes a pair of sprinkler conduits located to opposite sides of the storage system. Optionally, the plurality of sprinkler conduits includes a plurality of the sprinkler conduits to each of the opposite sides of the storage system. Optionally, the plurality of sprinkler conduits includes a plurality of rows of the sprinkler conduits located to each of the opposite sides of the storage system, the rows being at different elevations. Optionally, the rows include lower, middle, and upper rows.

Optionally, the plurality of nozzles includes opposite nozzles located to opposite sides of the storage system and facing the storage system. Optionally, the plurality of nozzles includes a plurality of the nozzles to each of the opposite sides of the storage system and facing the storage system. Optionally, the plurality of nozzles includes a plurality of rows of the nozzles, each row comprising a plurality of nozzles, the nozzles located to each of the opposite sides of the storage system and facing the storage system, and the rows being at different elevations. Optionally, the rows include lower, middle, and upper rows.

Optionally, the fluid outlets are supported by the enclosure, independently of the storage system. Optionally, the fluid outlets are supported by side walls of the enclosure, whereas the storage system is floor mounted.

An advantage is a more adaptable container because the storage system is non-proprietary and can be reconfigured or dismantled without requiring compatibility with the recirculating fluid delivery system. For example, different storage systems may be provided for different customers, while the enclosure and recirculating fluid delivery system stay the same.

Optionally, the plurality of fluid outlets comprise an upper fluid outlet above a top shelf of the plurality of shelves. Optionally, the plurality of fluid outlets further comprise at least one lower fluid outlet below the top shelf, configured to direct fire suppressant towards one or more of the shelves below the top shelf.

Optionally, at least an upper shelf of the plurality of shelves comprises a plurality of drainage apertures to allow the fire suppressant to drain to an underlying one of the plurality of shelves. For example, optionally the upper shelf comprises a horizontal shelf plate comprising the plurality of drainage apertures. Optionally, each shelf comprises a plurality of said drainage apertures, from a top shelf to a bottom shelf, allowing the fire suppressant to drain to the container floor. Where the storage system instead comprises horizontally spaced upright frames, each upright frame may comprise a plurality of drainage apertures at least at the outlet-facing sides of the frame.

An advantage is improved fire suppression because the storage system is highly porous, allowing mist to freely circulate within the storage system, and condensed fire suppressant to drip through the storage system into a sump.

Optionally, the storage system comprises mesh panels defining the plurality of drainage apertures. Optionally, the storage system comprises one or more frames each formed from structural members, the structural members supporting one or more mesh panels. Optionally, the storage system comprises at least three or at least four levels of the shelves. Optionally, the vertically spaced shelves of the storage system are vertically spaced from each other by a height selected from the range 10 cm to 100 cm. Or, if horizontally spaced upright frames are used, their horizontal spacing may be selected from the range 10 cm to 100 cm.

Optionally, the recirculating fluid delivery system comprises a recirculation circuit configured to recover fire suppressant that has passed through the plurality of fluid outlets, wherein the recirculation circuit comprises a sump and one or more pumps, wherein the sump is configured to receive the fire suppressant from the interior space, and wherein the one or more pumps are configured to receive the fire suppressant directly or indirectly from the sump and are configured to pump the fire suppressant in a recirculation direction. Optionally, the sump comprises the sump inlet as defined earlier.

An advantage is improved fire suppression because battery fires can require many thousands of litres of water over several hours to extinguish. In situations where there is no external water supply available, the recirculation circuit can keep recirculating fire suppressant until it is stopped or until fire, heat, or smoke is no longer detected.

Optionally, the recirculation circuit comprises a particulate filter. Optionally, the particulate filter is located at an inlet of the sump. Optionally, the recirculation circuit comprises coarse and fine particulate filters. Optionally, the one or more pumps further comprise an inlet filter.

An advantage is that the large number of contaminants generated in a fire are prevented from clogging up the recirculating fluid delivery system.

Optionally, the one or more pumps of the recirculation circuit are configured to receive fire suppressant from opposite corner regions of the sump or of a tank, to allow continued recovery of fire suppressant while the container is orientated at a range of first slope angles and a range of second, perpendicular slope angles. Optionally, the one or more pumps comprise a pair of pumps, wherein each one of the pair of pumps is configured to receive fire suppressant from a different one of the opposite corner regions. Optionally, the one or more pumps of the recirculation circuit are configured to pump the fire suppressant into one of the one or more tanks of the recirculating fluid delivery system.

An advantage is enabling continuous pickup of the fire suppressant even if the container is tilted to an angle or subject to horizontal g-forces.

Optionally, the one or more tanks comprise a lower tank positioned beneath the storage system. Optionally, the lower tank extends beneath a floor level of the interior space. Optionally, the lower tank is the floor tank referred to earlier.

An advantage is improved portability because the height of the centre of gravity of the container is minimised.

Optionally, the storage system is supported at least in part by the lower tank such that the lower tank bears a weight load of the storage system. Optionally, the lower tank comprises a tank structure, and reinforcing members to transfer the weight load from feet of the storage system to a base of the lower tank. Optionally, the reinforcing members comprise internal reinforcing members inside a tank interior of the lower tank. Optionally, the reinforcing members comprise upright plates connected to an upper wall of the lower tank and the base of the lower tank. Optionally, where the lower tank is the floor tank, the reinforcing members may be connected to the flat portion of the floor configured to receive the weight load of the storage system. Optionally, the reinforcing members may be arranged as internal baffles of the lower tank.

Optionally, the lower tank is alongside the sump. Optionally, the lower tank is separated from the sump by a divider forming a plan view boundary of the sump. Optionally, the divider is separate from and inboard of the internal reinforcing members.

Optionally, the recirculating fluid delivery system comprises two of the lower tanks, one located to each side of a centreline of the container. Optionally, the sump is located between the lower tanks. Alternatively, a single lower tank surrounds the sump.

An advantage is ensuring controlled weight distribution of fire suppressant. The weight distribution is passively controlled without needing to pump the fire suppressant between multiple floor tanks.

Optionally, at least one of the tanks, such as the lower tank, comprises a tank interior which comprises internal baffles configured to limit flowing of the fire suppressant while the container is in transit. Optionally, the internal baffles are spaced along the lower tank along each of the three or four sides of the base of the container. Optionally, the reinforcing members as described above define the internal baffles.

An advantage is improved portability because the baffles limit flow forces during transportation.

Optionally, the storage system comprises a plurality of shelf units, such as stillages, stackable on each other, and wherein each shelf unit comprises one of the plurality of shelves.

Optionally, each shelf unit comprises a plurality of legs, and wherein the shelf units are stackable on each other by interconnecting first ends of the legs of a first shelf unit with opposite second ends of the legs of a second shelf unit. The first and second ends may be bottom and top ends. Optionally, one of the ends is flared relative to the other, causing the shelf units to self-align when being stacked. Optionally, the bottom one of the ends is flared relative to the top end.

An advantage is a fire-safe environment for conveniently storing flammable articles in a supply chain, where products regularly need to be loaded into and unloaded from the container.

Optionally, the legs protrude below a shelf level of the shelf unit so that lifting members are insertable under the floor level and above bottoms of the legs.

An advantage is providing space beneath the bottom shelf unit to insert forklift tines. An entire stack of shelf units could be lifted.

Optionally, the storage system is centrally located in the interior space. Alternatively, the storage system comprises a pair of lateral shelving racks, and a central corridor extending therebetween from a first end of the container where the at least one door is located, towards a second opposite end of the container. Optionally, the corridor has a width of less than 1.5 metres.

An advantage of the corridor is a version of the container suitable for human workers to enter and place and retrieve flammable articles. The corridor further allows mist circulation.

Optionally, the enclosure comprises one or more ventilation ports.

An advantage is improved fire suppression by restricting the buildup of pressure, flammable gases, and heat inside the interior space. This reduces the risk of a thermal runaway or explosion. This is particularly useful when the flammable articles comprise batteries, because battery fires can produce flammable gases such as hydrogen, which can increase the risk of an explosion. Therefore, the ventilation port allows the flammable gas to be evacuated and dispersed into the external environment where it is no longer a risk.

Optionally, the one or more ventilation ports comprise a first ventilation port located to a first side of the enclosure and a second ventilation port located to a second side of the enclosure. The second side may be opposite the first side.

An advantage is improved fire suppression, because if one or more of the ventilation ports are on a windward side of the container and encounters an adverse pressure gradient, there are also one or more ventilation ports on a leeward side of the container. Therefore, a favourable pressure gradient will always exist for one or more of the ventilation ports, for evacuating smoke or flammable gases.

Optionally, the one or more ventilation ports comprise an insect filter, such as a mesh. An advantage is protecting the flammable articles from damage or soiling.

Optionally, the one or more ventilation ports comprise a port elevation of at least two metres above a bottom of the container. Optionally, the one or more ventilation ports are located proximal to the top of one or more side walls of the enclosure, and/or are located in a roof of the enclosure.

An advantage is improved removal of smoke and hot or flammable gases, because they are expelled above the head height of an adult worker.

Optionally, the enclosure comprises a blowout panel configured to allow gases to exit the container in dependence on a threshold pressure being reached in the interior space.

An advantage is improved fire control because the energy from an explosion or excessive pressure can be directed through a predetermined weak point of the container, to protect the container from explosive structural failure.

Optionally, the blowout panel is located at a roof of the enclosure, and is configured to allow gases to exit the container in an upwards direction when the blowout panel opens.

An advantage is that the energy is directed away from ground level personnel.

Optionally, the blowout panel covers an opening of the enclosure and is secured in a closed position by a pressure-activated release mechanism configured to fail when the threshold pressure is reached, wherein when the pressure-activated release mechanism fails, the blowout panel is configured to swing open about a hinge or otherwise remain tethered to the container. Alternatively, the blowout panel is secured in the closed position only by a weight of the blowout panel.

An advantage is improved fire control because the blowout panel remains hingedly connected or tethered to the enclosure when it opens, rather than being ejected as a projectile.

Optionally, a sealing strip is provided between the blowout panel and the opening. An advantage is preventing rain water from seeping into the container.

Optionally, the container is a portable container.

Optionally, the portable container comprises the dimensions of an intermodal container or roofed roll-off container. For example, the container may be a repurposed ISO container. These are understood terms of the art. ‘ISO’ means ‘International Organization for Standardization’. For example, the container may have a length of up to 40 feet and a width of up to 8 feet.

An advantage is allowing for convenient road, rail, or ship transportation to a site.

Optionally, the portable container comprises forklift tine-receiving channels.

An advantage is allowing the container to be picked and moved using handling equipment that is readily available at warehouses or similar facilities.

Optionally, the portable container comprises corner castings having clamping holes. Optionally, the corner castings are ISO corner castings.

An advantage is a standardised means for allowing the container to be attached to a chassis for transportation, and also lifted and moved.

Optionally, the portable container comprises ground-engaging wheels.

Optionally, the at least one door of the enclosure comprises vertically spaced door hinges configured to allow the door to rotate about a vertical axis.

Optionally, the at least one door of the enclosure comprises a fluid diverter member on an inner surface of the door, which is sloped towards the interior space when the door is closed and comprises a drip edge.

An advantage is that the drip edge prevents droplets of the fire suppressant from reaching a bottom region of the inner surface of the door. This prevents water from escaping through the bottom of the door.

Optionally, the at least one door of the enclosure comprises a generally fluid-tight seal extending around at least a substantial part of a periphery of the door.

An advantage is preventing the leakage of smoke or hot or flammable gases around the door, or the entry of oxygen into the container around the edges of the door.

Optionally, the enclosure provides a pair of the doors, openable in opposite rotation directions than each other.

Optionally, the container comprises a detector, optionally at least one of a heat detector, a flame detector, or a smoke detector. The detector is configured to detect a fire or thermal runaway event within the container and output an alert, optionally wherein the detector comprises one of a video camera, an infra-red video camera, a thermocouple, an array of thermocouples, or a smoke detector.

Optionally, the container comprises a telemetry module configured to output an alert to a server remote from the container, in dependence on a trigger signal from the detector. Optionally, the container comprises an alarm module configured to render an audible and/or visual alarm at the container.

Optionally, the container comprises flow control means for controlling the flow of fire suppressant within the container. Optionally, the flow control means comprises one or more pumps, and/or one or more fluid valves such as check valves.

Optionally, the one or more tanks comprise an upright wall-mounted tank, extending up a side wall of the enclosure. Optionally, the upright wall-mounted tank is an exterior wall-mounted tank mounted to an exterior side of the side wall.

An advantage is providing additional fire suppressant storage capacity without significantly increasing the plan view footprint of the container, and without further encroaching into the interior space of the container.

Optionally, at least one of the tanks comprises a fluid inlet in an upper portion of the tank, and a fluid inlet valve or removable cap. For example, the upright wall-mounted tank may be fluidly coupled to the fluid inlet. Optionally, the recirculating fluid delivery system comprises at least one hose coupling presented at an exterior of the container. For example the hose coupling may define the fluid inlet and may comprise the fluid inlet valve, as defined above.

An advantage is allowing fresh fire suppressant to be loaded into the container, for example to replace old or contaminated fire suppressant.

Optionally, the recirculating fluid delivery system comprises a drain presented at the exterior of the container. Optionally, the drain comprises a hose coupling.

An advantage is allowing contaminated fire suppressant to be removed after a fire has been treated, or replaced during a fire while the fluid inlet is also being used. A hose may be connected to the drain and run to a nearby disposal tank, for example.

According to various, but not necessarily all, embodiments of the invention the container is a battery storage container for storing batteries.

According to various, but not necessarily all, embodiments of the invention, the container is novel and can be claimed separately from the storage system. There is provided a container for storing flammable articles, optionally batteries, the container comprising:
an enclosure defining an interior space, the enclosure comprising at least one door for accessing the interior space; and
a recirculating fluid delivery system comprising one or more tanks configured to store a fire suppressant, and a plurality of fluid outlets configured to output the fire suppressant into the interior space. The container may further comprise any one or more of the features defined above.

### BRIEF DESCRIPTION OF THE DRAWINGS

For a better understanding of various examples of embodiments of the present invention reference will now be made by way of example only to the accompanying drawings in which:

FIG. 1 illustrates a side elevation view of a container;

FIG. 2 illustrates a front elevation view of a container;

FIG. 3 illustrates a perspective side cross-section view of a container;

FIG. 4 illustrates a side elevation cross-section view of a container;

FIG. 5 illustrates a rear perspective view of a container;

FIG. 6 illustrates a front elevation view of a container;

FIG. 7 illustrates a perspective view of a shelf unit;

FIG. 8 illustrates a front elevation view of a container;

FIG. 9 illustrates a plan view of an interior of a container;

FIG. 10 illustrates a front elevation view of a container; and

FIG. 11 illustrates a schematic view of a recirculating fluid delivery system.

### DETAILED DESCRIPTION OF VARIOUS EMBODIMENTS OF THE INVENTION

The FIGS illustrate examples of a portable container 100 comprising a storage system 300 for storing flammable articles such as electrical energy storage devices (not shown). The electrical energy storage devices may comprise batteries, such as lithium ion batteries, for example. The batteries may be high capacity batteries for automotive use, for stationary battery energy storage systems, or for any other use.

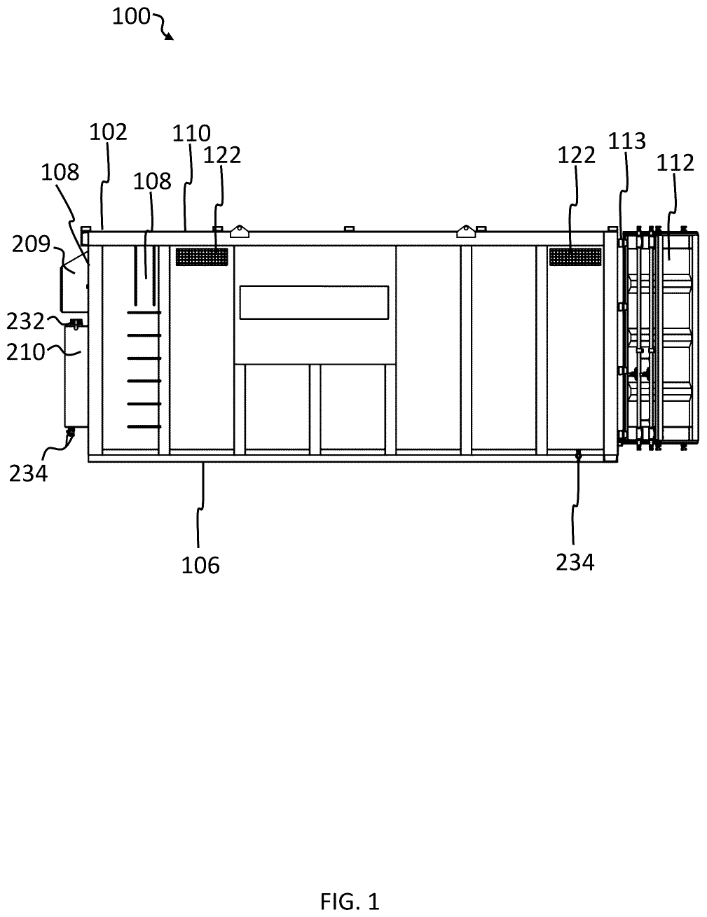

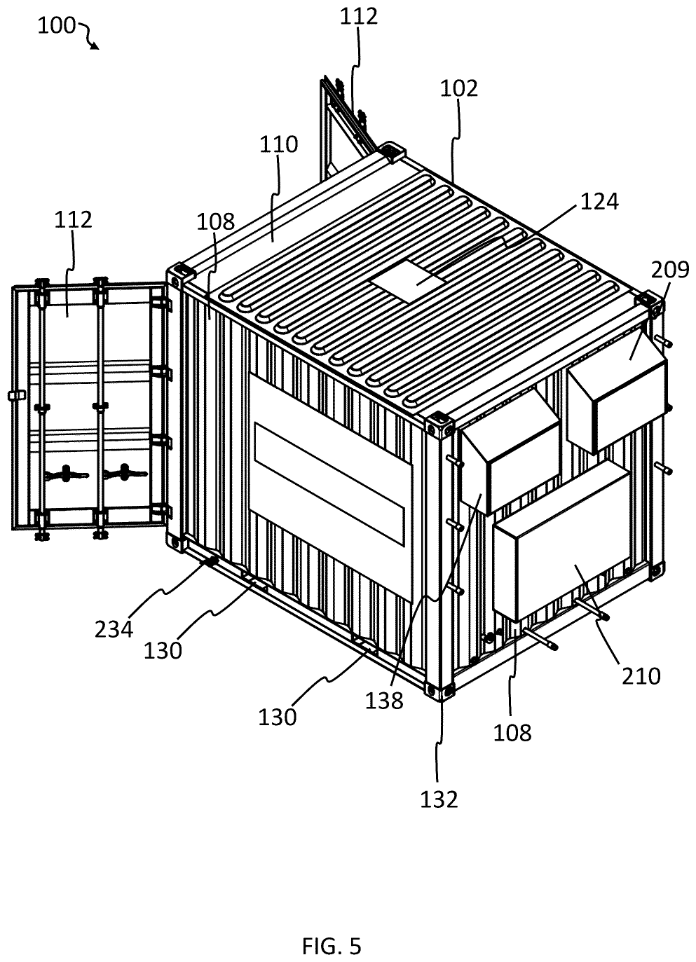

The portable container 100 comprises the dimensions of an intermodal container. FIGS. 1-4 illustrate a converted 40 ft shipping container, having a length of approximately 12-12.5 metres (40 feet), a width of approximately 2-2.5 metres (8 feet), and a height of approximately 2-3 metres (8.5 feet). FIGS. 5-9 illustrate a converted 20 ft shipping container in which the length is approximately 6-6.5 metres (20 feet). The container 100 may be a repurposed ISO container.

The above dimensions allow for convenient road, rail, or ship transportation to a site. As shown in FIG. 5, the portable container 100 may comprise corner castings 132 having clamping holes. Optionally, the corner castings 132 are ISO corner castings 132. These improve the portability of the container 100. Optionally, the portable container 100 may further comprise ground-engaging wheels.

As shown in FIG. 5, the container 100 may also comprise forklift tine-receiving channels 130, formed in a sandwich base 106 of the container 100. The container 100 can therefore be picked up by a forklift truck.

The container 100 comprises an enclosure 102 defining an interior space 104. The enclosure 102 comprises a base 106, side walls 108, a roof 110, and a pair of doors 112, collectively sealing the interior space 104 from an external environment. The side walls 108 and roof 110 may each comprise corrugated metal panels, such as steel.

The side walls 108 include a pair of long side walls 108, connected along their rear edges by a short side wall 108. The long side walls 108 are connected along their top edges by the roof 110. The doors 112 are connected to the front edges of the long side walls 108.

The container 100 also comprises a recirculating fluid delivery system 200 for spraying a fire suppressant such as water. This will be described in more detail later.

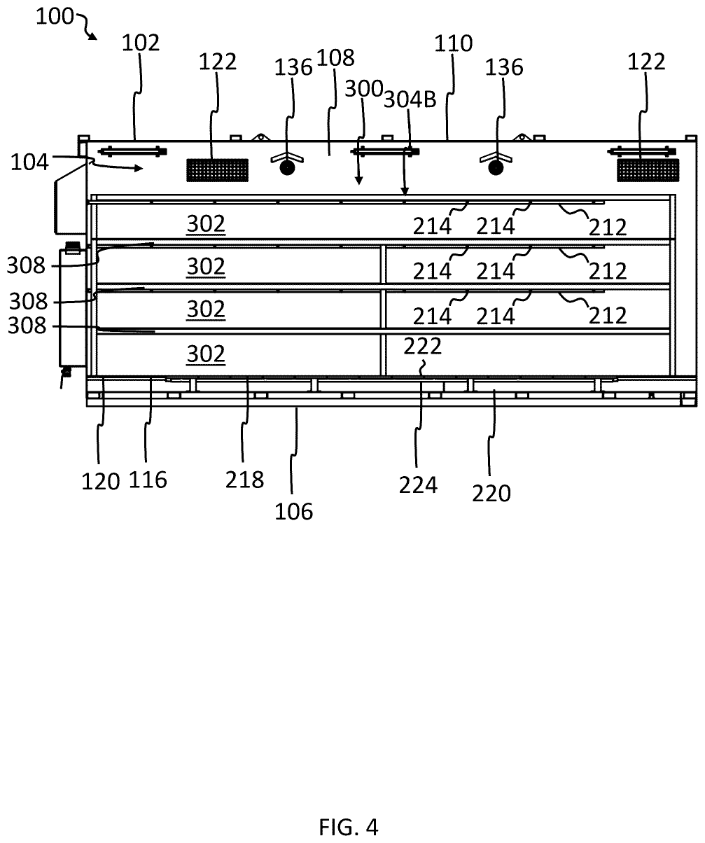

The interior space 104 may be fluid tight from the external environment, except for some optional ventilation ports 122 shown in FIGS. 1 and 4.

The interior space 104 is accessed through the pair of doors 112 at one end face of the container 100. The pair of doors 112 are each connected to one of the long side walls 108 of the container 100 by hinges 113, and are rotatable in opposite directions about vertical axes.

Each door 112 has an inner side facing the interior space 104 when the door 112 is closed, and an outer side. A generally fluid-tight sealing strip may extend along the perimeter of the door 112 at the inner side of the door 112, to seal one or more edges of the door 112 against one or more of a side wall 108, the roof 110, or the base 106. The sealing strip can comprise a compressible polymeric material, for example.

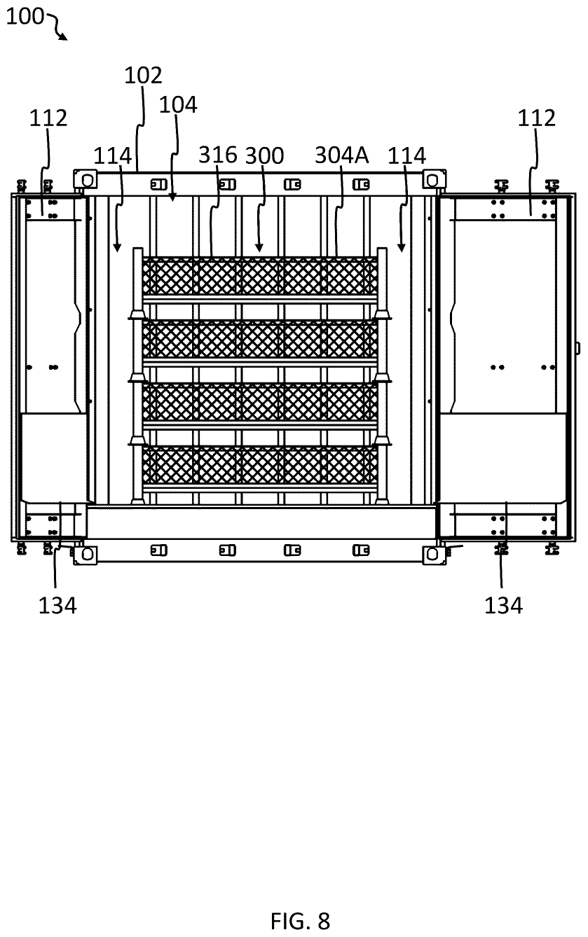

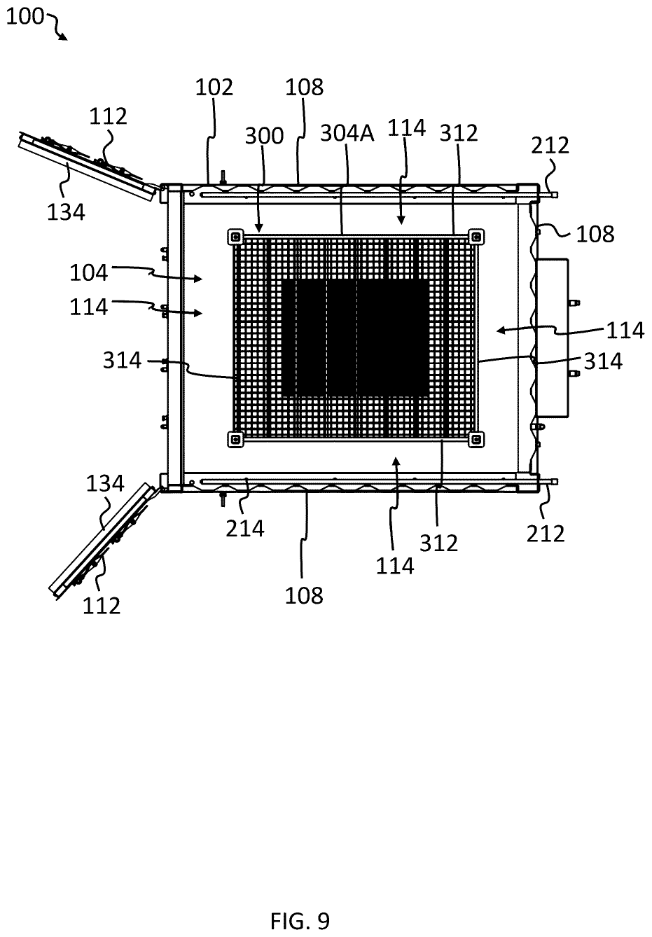

FIGS. 8-9 also show that a diagonally-sloped fluid diverter member 134 may be secured to the inner side of the door 112. The diverter member 134 is in the form of a diagonally-sloped plate which slopes to a drop edge offset inwardly from the inner surface of the door 112. Water drips off the drip edge onto the floor 116 of the container 100. The drip edge prevents water flowing down the door 112 from reaching the bottom of the door 112, to prevent water from escaping through the bottom of the door 112.

The container 100 further comprises detector apparatus 136 configured to detect a fire or thermal runaway event. The detector apparatus 136 can comprise a heat detector such as a thermocouple. The detector apparatus 136 can comprise a flame detector such as a video camera or infra-red video camera. The detector apparatus 136 can comprise a smoke detector, such as an ionization smoke detector or a photoelectric smoke detector. The detector apparatus 136 is mounted to the inner side of a side wall 108 or door 112, proximal to the top end of the side wall 108 or door 112.

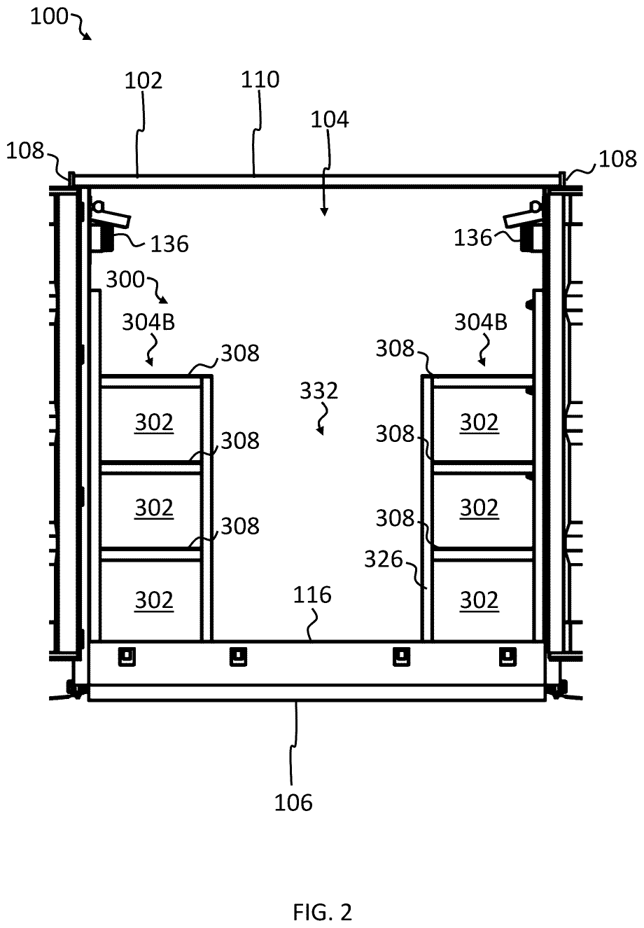

FIGS. 2 and 4 show that the container 100 may comprise a plurality of the same type of detector 136, at different positions within the interior space 104.

For example, FIG. 2 illustrates a detector 136 mounted to one of the long side walls 108, and another one of the same type of detector 136 mounted to the other long side wall 108. This allows rapid detection of a fire starting on either side of the container 100

Furthermore, FIG. 4 illustrates a detector 136 mounted at a first longitudinal position along one of the long side walls 108, and another one of the same type of detector 136 mounted at a second longitudinal position along the same side wall 108. This allows rapid detection of a fire starting towards either end of a long container 100.

As shown in FIG. 5, the container 100 can also comprise an electrical apparatus 138 such as a module containing various electrical systems of the container 100.

For example, the electrical apparatus 138 can comprise an onboard power source such as a battery, and/or an electrical power receptacle.

The electrical apparatus 138 can comprise a telemetry module configured to output an alert to a server remote from the container 100, in dependence on a trigger signal from one of the detectors 136. The telemetry module can comprise a transmitter or transceiver, and a controller including a processor and memory, collectively configured to output a wireless signal comprising the alert. The wireless signal may be transmitted to a wireless local area network, or a wireless cellular communication network, for example.

Optionally, the electrical apparatus 138 of the container 100 comprises an alarm module configured to render an audible and/or visual alarm at the container 100 in dependence on the trigger signal. Therefore, nearby personnel are alerted to a fire or thermal runaway.

In the event of a fire, the atmospheric pressure inside the container 100 will increase if it is fully sealed. This can cause risk of an explosion. Therefore, ventilation ports 122 are provided along each long side wall 108, proximal to the upper end of the side wall 108.

The ventilation ports 122 allow smoke and hot gases to egress the container 100 at a controlled rate, and are therefore located above head height so that nearby personnel are protected from smoke. For example, the ventilation ports 122 are elevated at least two metres above the base 106 of the container 100. Alternatively, the ventilation ports 122 may be formed in the roof 110 of the container 100.

FIGS. 1 and 4 show that each side of the container 100 may comprise at least one ventilation port 122. For example, each long side wall 108 may comprise at least one ventilation port 122. Therefore, even if one ventilation port 122 encounters a higher external pressure than internal pressure, due to wind, the other ventilation port 122 on the leeward side of the container 100 should have a favourable pressure gradient for expulsion of smoke and gases from the container 100.

Furthermore, if the container 100 is a long container such as a 40 ft container, FIGS. 1 and 4 show that ventilation ports 122 may be located at more than one longitudinal position. The illustrated ventilation ports 122 are spaced longitudinally along a long side wall 108.

The illustrated ventilation ports 122 further comprise an insect filter such as a mesh, to prevent soiling of the contents of the container 100.

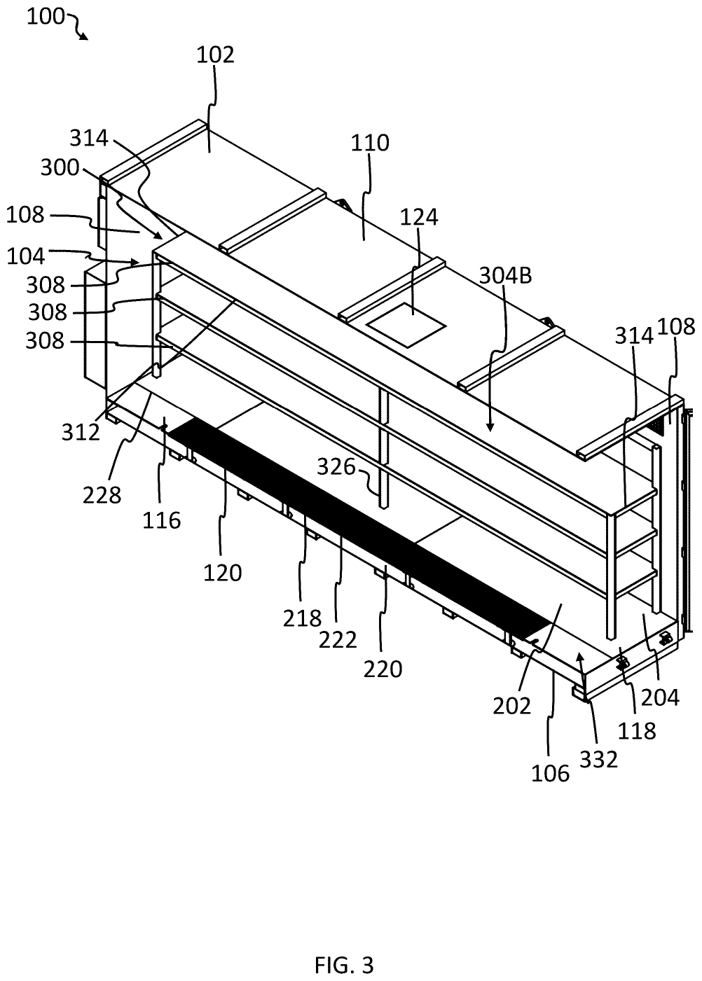

FIGS. 3 and 5 further illustrate that the enclosure 102 may comprise a blowout panel 124 configured to allow gases to exit the container 100 in dependence on a threshold pressure being reached in the interior space 104. The blowout panel 124 is useful when a rapidly building fire or conflagration may exceed the capability of the ventilation ports 122 to expel gases. The blowout panel 124 is also useful if the container 100 does not have any ventilation ports 122. The blowout panel 124 prevents explosions or structural failure of the container 100.

The blowout panel 124 covers an opening in the roof 110 of the container 100 which has a larger area than a ventilation port 122. Therefore, when the blowout panel 124 is open, the available area for expulsion of gases is significantly increased.

The blowout panel 124 may be secured to the enclosure 102 by a hinge. The blowout panel 124 may be secured in a closed position by its own weight. When the pressure difference across the blowout panel 124 reaches the threshold pressure, the internal pressure of the container 100 may lift the blowout panel 124 from its closed position to an open position, so that the gases can escape.

In some examples, the blowout panel 124 may be secured in its closed position by a pressure-activated release mechanism, such as press studs.

In some examples, the blowout panel 124 may be tethered to the enclosure 102 not only by the hinge but also by chain links, plastic ties, or a hook and eye system, for example. These may limit its degree of opening, and may prevent it from slamming open.

Optionally, a sealing strip is provided between the opening of the enclosure 102, and the side of the blowout panel 124 which faces the interior space 104. This prevents rain water from seeping into the container 100 around the blowout panel 124. The sealing strip can comprise a compressible polymeric material, for example.

FIGS. 1-4 also illustrate a first example of a storage system 300 within the interior space 104, the storage system 300 comprising a plurality of vertically spaced shelves 302 each defining a compartment configured to store one or more of the flammable articles.

The storage system 300 comprises left and right lateral shelving racks 304A, one to each side of the interior space 104, and a central corridor 332 extending therebetween from a first end of the container 100 where the doors 112 are located, towards the opposite end of the container 100.

The left and right shelving racks 304A are positioned against the long side walls 108 of the container 100, leaving a space therebetween with a width of up to 1.5 metres for use as a corridor 332.

This arrangement allows human workers to walk along the central corridor 332, and place and retrieve flammable articles on the shelves 302.

Each shelving rack 304A comprises legs 326 supporting a plurality of shelf plates 308. Each shelving rack 304A may comprise at least three or at least four levels of shelf plates 308. The levels of shelf plates 308 may be vertically spaced from each other by a height selected from the range 10 cm to 100 cm.

Although not shown, each shelf plate 308 of the shelving rack 304A may comprise drainage apertures to allow water to drip through to the underlying shelf plate 308, and eventually reach the bottom of the shelving rack 304A.

The legs 326 of the shelving rack 304A rest on a false floor 116 of the container 100. The false floor 116 of the container 100 conceals a sump 220 and a pair of floor tanks 202 alongside the sump 220. These are parts of the recirculating fluid delivery system 200. The sump 220 is located centrally, and the floor tanks 202 are offset to its left and right sides, separated from the left and right sides of the sump 220 by divider walls 228.

The sump 220 extends longitudinally along the central corridor 332, and is covered by a grate 222 on which personnel can walk. The grate 222 may be supported at its mid-span by internal pillars within the sump 220, the internal pillars connecting the grate 222 to the base 106 of the container 100.

The grate 222 defines a sump inlet 218 of the sump 220, into which water can drain. The grate 222 may be substantially flat and horizontal, and defines a flat portion 120 of the false floor.

The floor tanks 202 comprise tank structures formed from plates. A top plate 204 of the tank structure defines part of the false floor 116 of the container 100. The top plate 204 of the tank structure of the floor tank 202 may be gently sloped towards the sump inlet 218, by an angle which is too small to see in the FIGS. This promotes the drainage of water from the shelving rack 304A to the sump inlet 218. These slopes define sloped portions 118 of the false floor 116 of the container 100.

For stability, the legs 326 of the shelving racks 304A are positioned on flat portions 120 of the false floor 116. For example, the top plate 204 of the tank structure of the floor tank 202 may comprise one or more flat portions 120 located beneath the legs 326 of the shelving rack 304A. In some examples, the front legs 326 of the shelving rack 304A may rest on the flat sump inlet 218.

Therefore, the false floor 116 of the container 100 is configured to receive the weight load of the shelving racks 304A, and transfer the weight loads to the base 106 of the container 100. Internal reinforcement may be provided inside the tank interior 208 of the floor tank 202, such as internal reinforcing members 206 (not visible in FIG. 3) which are upright plates connected to the divider wall 228 and top plate 204 of the tank structure of the floor tank 202 as well as the base 106 of the container 100. They function as braces. The internal reinforcing members 206 may be aligned with the flat portions 120 of the false floor 116 on which the legs 326 of the shelving racks 304A rest. Therefore, the false floor 116 is stiffest where the loads are highest.

If the internal reinforcing members 206 are within the floor tanks 202, they may also function as internal baffles to restrict water movement and slosh forces.

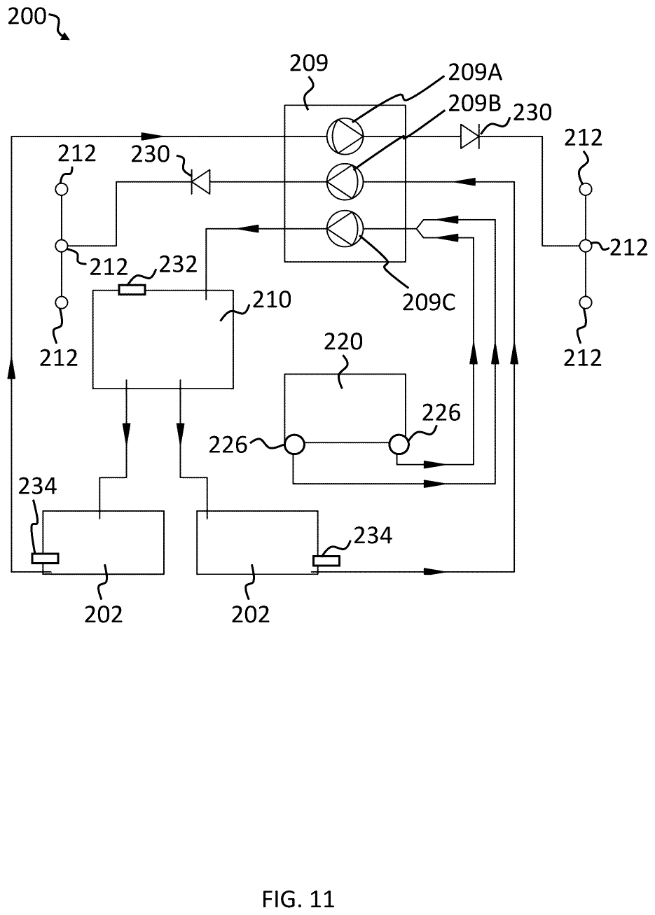

With reference to FIG. 11, the container 100 comprises a recirculating fluid delivery system 200. The system comprises the floor tanks 202 as well as an external upright wall-mounted tank 210, for storing the water.

The external upright wall-mounted tank 210 extends up the exterior side of the short side wall 108 of the enclosure 102. The system can be filled with water by a water inlet 232 located in an upper portion of the upright wall-mounted tank 210. The water inlet 232 may be covered by a removable cap. In some examples, the water inlet 232 may comprise a fluid inlet valve such as a hose coupling.

The upright wall-mounted tank 210 is fluidly connected to the left and right floor tanks 202 by water lines. Water is gravity-fed into the floor tanks 202, and when the floor tanks 202 are full, the upright wall-mounted tank 210 will start to fill as well.

The total combined capacity of the tanks may be in the order of 500 to 2000 litres.

Should the tanks need to be drained, the floor tanks 202 each comprise a drain outlet 234 presented at the exterior of the container 100. Each drain outlet 234 is located in a lower portion of the corresponding floor tank 202. Optionally, the drain outlet 234 comprises a hose coupling.

FIG. 11 also illustrates a plurality of sprinkler pipes 212 (sprinkler conduits) coupled to the tanks via a pump apparatus 209 and configured to deliver the water to a plurality of nozzles 214 (fluid outlets) pictured in FIGS. 4, 6, and 9. The nozzles 214 spray the water into the interior space 104 of the container 100, to reduce the temperature of the flammable articles to a sub-ignition temperature.

FIG. 11 illustrates two sets of three sprinkler pipes 212. The first set of sprinkler pipes 212 is located to the left side of the container 100, and comprises lower, middle, and upper sprinkler pipes 212 each mounted at different vertical heights to the left long side wall 108. The second set of sprinkler pipes 212 is located to the right side of the container 100, and comprises lower, middle, and upper sprinkler pipes 212 each mounted at different vertical heights to the right long side wall 108.

The upper sprinkler pipe 212 may be located above the top shelf plate 308 of the storage system 300, and may be orientated downwardly towards the top shelf plate 308. The middle sprinkler pipe 212 may be located between the top shelf plate 308 and a lowest shelf plate 308. The lower sprinkler pipe 212 may be located at least one shelf level below the middle sprinkler pipe 212.

As shown in FIG. 4, each sprinkler pipe 212 may be generally straight and horizontal, and comprises a plurality of nozzles 214 spaced longitudinally along its length. Each nozzle 214 comprises atomising holes configured to output an atomised water mist in a direction towards a longitudinal centreline of the container 100. Each sprinkler pipe 212 represents a manifold for distributing the water to the nozzles 214.

The lines in FIG. 11 which interconnect the tanks and pump apparatus 209 represent conduits such as pipes, and the arrowheads represent flow direction.

FIG. 11 shows that the flow of water from the tanks to the sprinkler pipes 212 is governed by a pump apparatus 209, and optional check valves 230 to prevent reverse flow. The pump apparatus 209 is activated automatically in dependence on a trigger signal from the detector 136, to initiate pumping of water from the tanks to the nozzles 214. Alternatively, or additionally, the pump apparatus 209 can be activated manually.

The pump apparatus 209 comprises a pair of pumps 209A, 209B, including a first pump 209A fluidly connected to the left floor tank 202 and configured to supply water to one of the sets of sprinkler pipes 212, and a second pump 209B fluidly connected to the right floor tank 202 and configured to supply water to the other set of sprinkler pipes 212.

For the storage system 300 of FIGS. 1-4, the central corridor 332 advantageously allows water mist to circulate within the interior space 104. Droplets are suspended in the air, and pass to all areas of the container 100. When water droplets condense on the shelving racks 304A and the flammable articles, the water may drip through the apertures of the shelf plate 308 onto the underlying shelves 302.

The recirculating fluid delivery system 200 further comprises a recirculation circuit configured to recover water that has passed through the plurality of nozzles 214 and dripped or settled on the floor 116 of the container 100. FIG. 11 shows that the recirculation circuit comprises the earlier-described sump 220, and a pair of sump pumps 226 configured to pump recovered water from the sump 220 to the upright wall-mounted tank 210.

The water flows into the sump 220 through the grate 222 of the sump inlet 218, shown in FIGS. 3, 4, and 6. The sloped portions 118 of the false floor 116 helps the water to drain into the sump inlet 218. Since the water may be contaminated, the sump inlet 218 may further comprise coarse and fine particulate filters 224. One or more of the pumps 209, 226 may also comprise an inlet particulate filter at its inlet.

Although not shown in FIG. 11, the sump pumps 226 may be located towards opposite corners of the sump 220 than each other, to ensure that water is captured even if the container 100 is tilted. Alternatively, pickup tube inlets for one or more sump pumps 226 may be located towards the opposite corners of the sump 220.

The pump apparatus 209 comprises an additional pump 209C whose inlet is connected to the outlets of the sump pumps 226, wherein the additional pump 209C is configured to further increase the pressure of the water to recirculate the water back into the upright wall-mounted tank 210. In other examples, if the sump pumps 226 are powerful enough, the additional pump 209C may not be needed.

FIGS. 5-9 illustrate a second example of a storage system 300, which may be used in either version of the container 100. The storage system 300 comprises a plurality of vertically stacked independent shelf units, each shelf unit defined herein as a stillage 304B.

The stack of stillages 304B is centrally located in the interior space 104. Each stillage 304B comprises one shelf 302. The stack provides a plurality of shelves 302.

Each stillage 304B comprises a plurality of legs 326 with a flared bottom end 328 and a non-flared top end 330. The stillages 304B are stackable on each other by interconnecting the flared bottom ends 328 of the legs 326 of a first stillage 304B with the non-flared top ends 330 of the legs 326 of a second stillage 304B. The flared bottom ends 328 cause the stillages 304B to self-align when being stacked.

A plurality of beams 324 are connected to the sides of the legs 326, elevated above the flared bottom ends 328 of the legs 326. The beams 324 interconnect the legs 326. A mesh panel 310 is connected to the beams 324, the mesh panel 310 defining a porous shelf plate 308 for supporting flammable articles. The mesh panel 310 may also be supported from below by a plurality of slats.

The shelf plate 308 is elevated above the bottoms of the legs 326 by a sufficient vertical distance that lifting members, such as forklift tines, are insertable under the floor level and above bottoms of the legs 326. This allows a stillage 304B to be lifted off the stack by a forklift truck.

The porosity of the mesh panels 310 allows condensed water to drip down from the overlying stillages 304B to the underlying stillages 304B, and eventually to the false floor 116 of the container 100 where it flows into the sump 220.

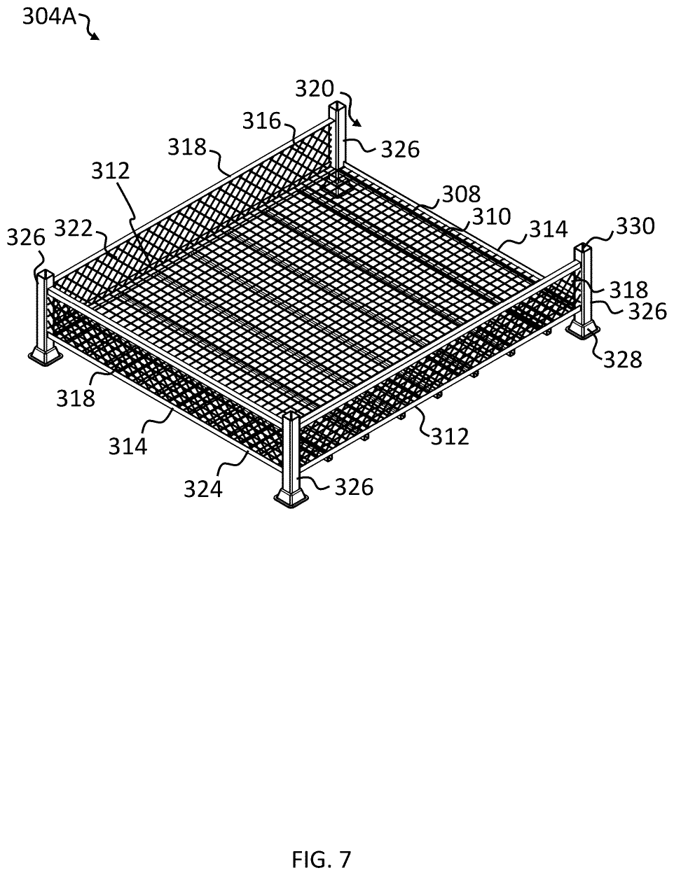

Furthermore, each stillage 304B is located in the centre of the enclosure 102, away from the side walls 108, and is therefore surrounded on all four sides by a peripheral mist circulation gap 114. To prevent flammable articles from sliding or falling off the edges of the stillage 304B into the peripheral mist circulation gap 114, FIGS. 7 and 8 show that the stillage 304B can comprise an upright barrier arrangement 316 of barrier walls 316

Each barrier wall 316 comprises an upper horizontal rail connected to a pair of legs 326, a parallel lower rail such as one of the beams 324 described above, and an upright mesh panel 322 therebetween. The mesh panel 322 is porous to allow water mist to pass laterally through the barrier walls 316 and reach the flammable articles.

The barrier walls 316 extend along the longitudinal and lateral edges 312, 314 of the stillage 304B, to restrain flammable articles on the shelf plate 308. The barrier walls 316 comprise left, right, and rear barrier walls 316. The front edge of the stillage 304B does not have a front barrier wall, to provide a discontinuity/entrance 320 for placing and removing flammable articles.

The plan view of FIG. 9 illustrates the positioning of the stillages 304B within the enclosure 102. As shown, the stack of stillages 304B is surrounded on all four sides by a peripheral mist circulation gap 114. The peripheral mist circulation gap 114 allows an atomised mist of water droplets suspended in air to circulate freely within the interior space 104, and fill substantially the entire volume.

The width of the peripheral mist circulation gap 114 is defined as the plan view distance from the longitudinal edge 312 or lateral edge 314 of the stillages 304B to the nozzles 214 along the closest parallel side wall 108. The width may be in the order of 15 to 50 cm or 20 to 50 cm. At the bottom of the peripheral mist circulation gap 114, the false floor 116 of the container 100 may be sloped towards the sump 220 in the width direction.

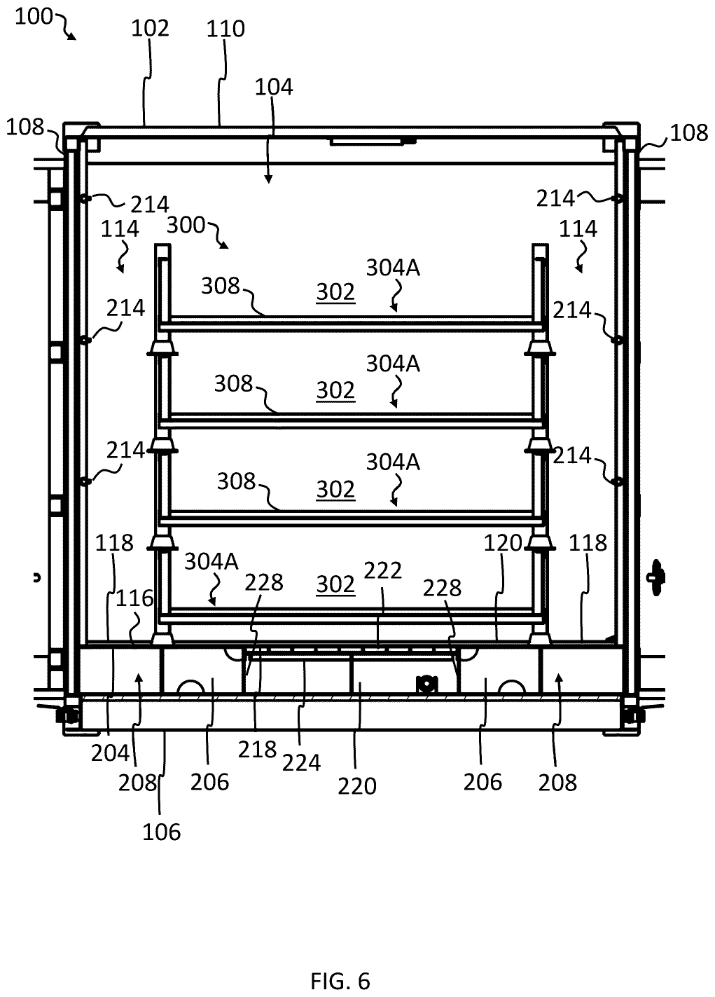

As best shown in FIG. 6, the legs 326 of the bottom stillage 304B of the stack may rest on flat portions 120 of the top plates 204 of the floor tanks 202. The illustrated legs 326 are located on mid-span regions of the top plates 204 of the floor tanks 202, away from the side walls 108 of the floor tanks 202. Therefore, the legs 326 are aligned with the internal reinforcing members 206 of the floor tanks 202 to ensure that the legs 326 are resting on stiffened/reinforced portions of the floor tanks 202. As described earlier, the internal reinforcing members 206 may also function as internal baffles, and may comprise apertures/cutouts allowing water to pass through the internal reinforcing members 206.

In some examples, water can be exchanged directly between the left and right floor tanks 202. This allows equal weight distribution across the floor tanks 202. In some examples, the left and right floor tanks 202 may be left and right main portions of a single larger tank structure wrapping around the sump 220. In other examples, the left and right floor tanks 202 are separate structures connected to each other by water pipes.

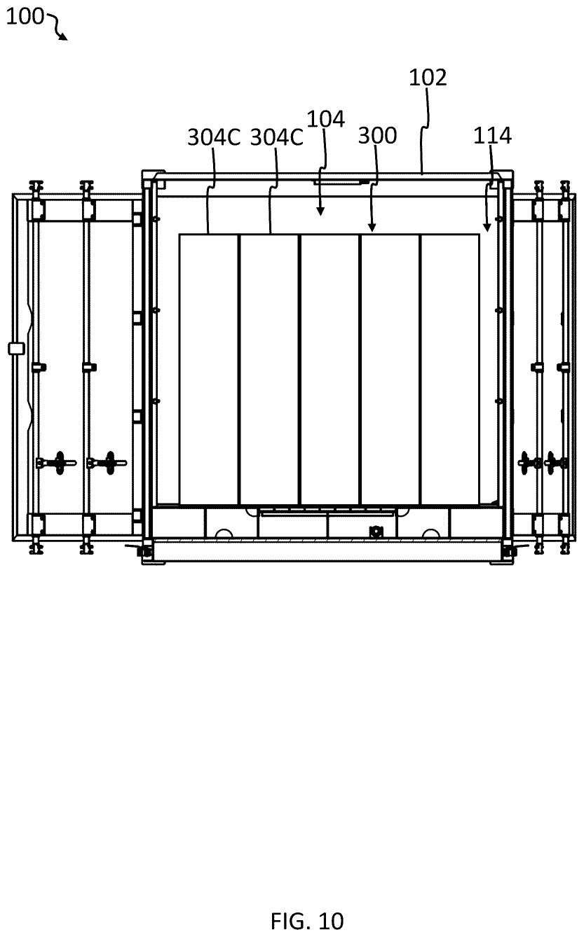

FIG. 10 illustrates a further alternative storage system 300, in which instead of vertically-separated shelves 302, a plurality of horizontally spaced upright frames 304° C. positioned alongside each other define the compartments. Their horizontal spacing may be selected from the range 10 cm to 100 cm. This storage system 300 can be used for larger articles such as battery modules for large appliances. Furthermore, the storage system 300 of FIG. 10 may be surrounded by a peripheral mist circulation gap 114 as defined earlier.

Although embodiments of the present invention have been described in the preceding paragraphs with reference to various examples, it should be appreciated that modifications to the examples given can be made without departing from the scope of the invention as claimed. For example, a fire suppressant other than water may be used. Furthermore, when water is used, it may comprise additives such as a fire-suppressing surfactant.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A container for storing flammable articles, the container comprising:
an enclosure defining an interior space, the enclosure comprising at least one door configured to enable access to the interior space;
a recirculating fluid delivery system comprising one or more tanks configured to store a fire suppressant, and a plurality of fluid outlets configured to output the fire suppressant into the interior space; and
a storage system within the interior space, the storage system comprising a plurality of compartments, each configured to store one or more of the flammable articles.

2. The container of claim 1, comprising a peripheral mist circulation gap extending between at least one elongate side of the storage system and a corresponding side wall of the enclosure, in plan view.

3. The container of claim 2, wherein the peripheral mist circulation gap extends continuously around three or four elongate sides of the storage system, in plan view.

4. The container of claim 1 wherein a first one of the shelves comprises an upright barrier arrangement extending along at least one edge region of the first shelf, to restrain a flammable article on the first shelf against falling into the peripheral mist circulation gap.

5. The container of claim 1, comprising a floor of the interior space, the floor comprising a sloped portion and a flat portion, wherein the sloped portion is located between the storage system and a side wall of the enclosure, wherein the sloped portion is orientated to drain the fire suppressant towards a sump inlet, and wherein at least part of the flat portion is configured to receive a weight load from the storage system.

6. The container of claim 1, wherein the recirculating fluid delivery system comprises a plurality of sprinkler conduits, and a plurality of nozzles connected to each sprinkler conduit and separated longitudinally or vertically from each other along the respective sprinkler conduit, each of the plurality of nozzles defining one of the plurality of fluid outlets, and wherein each of the plurality of nozzles includes opposite nozzles located to opposite sides of the storage system and facing the storage system.

7. The container of claim 1, wherein the plurality of fluid outlets are supported by the enclosure, independently of the storage system, and wherein the plurality of fluid outlets comprise an upper fluid outlet above a top shelf of the plurality of shelves.

8. The container of claim 1, wherein at least an upper shelf of the plurality of shelves comprises a plurality of drainage apertures to allow the fire suppressant to drain to an underlying one of the plurality of shelves.

9. The container of claim 1, wherein the recirculating fluid delivery system comprises a recirculation circuit configured to recover the fire suppressant that has passed through the plurality of fluid outlets, wherein the recirculation circuit comprises a sump and one or more pumps, wherein the sump is configured to receive the fire suppressant from the interior space, and wherein the one or more pumps are configured to receive the fire suppressant directly or indirectly from the sump and is configured to pump the fire suppressant in a recirculation direction.

10. The container of claim 9, wherein the one or more pumps are configured to receive the fire suppressant from opposite corner regions of the sump or of a tank, to allow continued recovery of the fire suppressant while the container is orientated at a range of first slope angles and a range of second, perpendicular slope angles.

11. The container of claim 1, wherein the one or more tanks comprise a lower tank positioned beneath the storage system, and wherein the storage system is supported at least in part by the lower tank such that the lower tank bears a weight load of the storage system.

12. (canceled)

13. The container of claim 1, wherein at least one of the tanks comprises a tank interior which comprises internal baffles configured to limit flowing of the fire suppressant while the container is in transit.

14. The container of claim 1, wherein the storage system comprises a plurality of shelf units stackable on each other and wherein each shelf unit comprises one of the plurality of shelves, or wherein the storage system comprises a plurality of horizontally spaced upright frames.

15-17. (canceled)

18. The container of claim 1, wherein the enclosure comprises a blowout panel configured to allow gases to exit the container in dependence on a threshold pressure being reached in the interior space.

19. The container of claim 18, wherein the blowout panel is located at a roof of the enclosure, and is configured to allow gases to exit the container in an upwards direction when the blowout panel opens.

20. The container of claim 1, wherein the container is a portable container comprising at least one of:
the dimensions of an intermodal container or roofed roll-off container;
forklift tine-receiving channels;
corner castings having clamping holes; or
ground-engaging wheels.

21. (canceled)

22. The container of claim 1, comprising a detector configured to detect a fire within the container and output an alert.

23. The container of claim 22, comprising a flow controller for controlling the flow of fire suppressant within the container, wherein the flow controller comprises a user input or is configured to be automatically controlled in response to a signal from the detector.

24. The container of claim 1, wherein the one or more tanks comprise an upright wall-mounted tank, extending up a side wall of the enclosure.

25. The container of claim 1, wherein the recirculating fluid delivery system comprises at least one hose coupling presented at an exterior of the container, and/or wherein the recirculating fluid delivery system comprises a drain presented at the exterior of the container.
